(19) United States
(12) Patent Application Publication
(10) Pub. No.: US 2019/0277571 A1
(43) Pub. Date: Sep. 12, 2019

(54) GANGED PLATE STACK IN CAST PLATE FIN HEAT EXCHANGER

(71) Applicant: United Technologies Corporation, Farmington, CT (US)

(72) Inventors: Michael A. Disori, Glastonbury, CT (US); William P. Stillman, Sturbridge, MA (US); Adam J. Diener, Marlborough, CT (US); Alexander Broulidakis, Tolland, CT (US); David J. Hyland, Portland, CT (US); Jeremy Styborski, Manchester, CT (US)

(21) Appl. No.: 15/914,055

(22) Filed: Mar. 7, 2018

(51) Int. Cl. F28D 9/00; B23P 15/26; F28F 3/08; F28F 9/02

(52) U.S. Cl. CPC F28D 9/0093; F28F 9/02; F28F 3/08; B23P 15/26

(57) ABSTRACT

A plate fin heat exchanger includes a first cast plate assembly includes at least two plate portions separated by at least one cooling channel. Each of the two plate portions include a plurality of internal passages extending between a corresponding plurality of inlets and outlets. A common inlet perimeter surrounds the plurality of inlets from each of the two plate portions and an outlet perimeter surrounds the plurality of outlets from each of the two plate portions. An inlet manifold is attached at an inlet joint to the inlet perimeter. An outlet manifold is attached at an outlet joint to the outlet perimeter. A method is also disclosed.

### BACKGROUND

A plate fin heat exchanger includes adjacent flow paths that transfer heat from a hot flow to a cooling flow. The flow paths are defined by a combination of plates and fins that are arranged to transfer heat from one flow to another flow. The plates and fins are created from sheet metal material brazed together to define the different flow paths. Thermal gradients present in the sheet material create stresses that can be very high in certain locations. The stresses are typically largest in one corner where the hot side flow first meets the coldest portion of the cooling flow. In an opposite corner where the coldest hot side flow meets the hottest cold side flow the temperature difference is much less resulting in unbalanced stresses across the heat exchanger structure. Increasing temperatures and pressures can result in stresses on the structure that can exceed material and assembly capabilities.

Turbine engine manufactures utilize heat exchangers throughout the engine to cool and condition airflow for cooling and other operational needs. Improvements to turbine engines have enabled increases in operational temperatures and pressures. The increases in temperatures and pressures improve engine efficiency but also increase demands on all engine components including heat exchangers.

Turbine engine manufacturers continue to seek further improvements to engine performance including improvements to thermal, transfer and propulsive efficiencies.

### SUMMARY

In a featured embodiment, a plate fin heat exchanger includes a first cast plate assembly includes at least two plate portions separated by at least one cooling channel. Each of the two plate portions include a plurality of internal passages extending between a corresponding plurality of inlets and outlets. A common inlet perimeter surrounds the plurality of inlets from each of the two plate portions and an outlet perimeter surrounds the plurality of outlets from each of the two plate portions. An inlet manifold is attached at an inlet joint to the inlet perimeter. An outlet manifold is attached at an outlet joint to the outlet perimeter.

In another embodiment according to the previous embodiment, a second cast plate assembly includes a second inlet perimeter attached to the outlet perimeter of the first cast plate assembly at an intermediate joint and the outlet manifold is attached to the outlet perimeter of the second cast plate assembly.

In another embodiment according to any of the previous embodiments, the first cast plate assembly includes a plurality of fin portions that extend from top and bottom surface of the plate portions.

In another embodiment according to any of the previous embodiments, at least one additional cast plate assembly with an inlet perimeter is attached at an additional inlet joint to the inlet manifold and an outlet perimeter is attached at an additional inlet joint to the outlet manifold.

In another embodiment according to any of the previous embodiments, the inlet manifold and the outlet manifold include a first passage in communication with the first cast plate assembly and a second passage in communication with the second cast plate assembly.

In another embodiment according to any of the previous embodiments, the at least two plate portions include three plate portions including a top plate portion, an intermediate plate portion and bottom plate portion with a cooling channel defined on either side of the intermediate plate portion.

In another embodiment according to any of the previous embodiments, the at least two plate portions include four plate portions including a top plate portion, a first intermediate plate portion, a second intermediate plate portion and a bottom plate portion with the cooling channel defined between the plate portions.

In another embodiment according to any of the previous embodiments, the inlet joint includes a brazed joint between the inlet perimeter and an internal surface of the inlet manifold and the outlet joint includes a brazed joint between the outlet perimeter and an internal surface of the outlet manifold.

In another embodiment according to any of the previous embodiments, the common inlet perimeter and the common outlet perimeter include smooth surfaces on outer surfaces of opposing distal ends.

In another embodiment according to any of the previous embodiments, the common inlet perimeter and the common outlet perimeter are parts separate from the first cast plate assembly.

In another embodiment according to any of the previous embodiments, the common inlet perimeter and the common outlet perimeter are integral parts of the first cast plate assembly.

In another embodiment according to any of the previous embodiments, the cast plate assembly includes a single unitary cast item.

In another featured embodiment, a plate fin heat exchanger includes a first cast plate assembly including at least two plate portions separated by at least one cooling channel. Each of the two plate portions include a plurality of internal passages extending between a corresponding plurality of inlets and outlets. An inlet perimeter surrounds the plurality of inlets from each of the two plate portions and an outlet perimeter surrounds the plurality of outlets from each of the two plate portions. A second cast plate assembly includes at least two second plate portions separated by at least one second cooling channel. Each of the two second plate portions include a second plurality of internal passages extending between a second corresponding plurality of inlets and outlets. The second cast plate assembly includes a second inlet perimeter surrounding the second plurality of inlets of the second cast plate that is attached to the outlet perimeter of the first cast plate assembly. An inlet manifold is attached at an inlet joint to the first inlet perimeter of the first cast plate assembly. An outlet manifold is attached at an outlet joint to the outlet perimeter of the second cast plate assembly.

In another embodiment according to the previous embodiment, the first cast plate assembly and the second cast plate assembly both include a plurality of fin portions that extend from top and bottom surfaces of the plate portions.

In another embodiment according to any of the previous embodiments, the inlet perimeter and the outlet perimeter are parts separate from the first cast plate assembly and the second cast plate assembly.

In another embodiment according to any of the previous embodiments, the inlet perimeter and the outlet perimeter are integral parts of the first cast plate assembly and the second cast plate assembly.

In another embodiment according to any of the previous embodiments, first cast plate assembly and the second cast plate assembly each include separate unitary cast items.

In another featured embodiment, a method of assembling a heat exchanger includes joining a first cast plate assembly to an inlet manifold at an inlet joint. The first cast plate assembly includes at least two plate portions separated by at least one cooling channel to an inlet manifold. Each of the at least two plate portions include a plurality of internal passages extending between a corresponding plurality of inlets and outlets and an inlet perimeter surrounds the plurality of inlets from each of the two plate portions and an outlet perimeter surrounds outlets from each of the two plate portions. An outlet manifold is joined at an outlet joint to the outlet perimeter of the first cast plate assembly.

In another embodiment according to the previous embodiment, second cast plate assembly is joined between the first cast plate and the outlet manifold. The second cast plate is identical to the first cast plate and a second inlet perimeter of the second cast plate is joined to the first outlet perimeter of the first cast plate at an intermediate joint and a second outlet perimeter of the second cast plate is jointed at the outlet joint to the outlet manifold.

In another embodiment according to any of the previous embodiments, the first cast plate and the second cast plate both include a plurality of fin portions extending from top and bottom surfaces of the at least two plate portions.

In another embodiment according to any of the previous embodiments, first cast plate assembly and the second cast plate assembly each include separate unitary cast items.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example heat exchanger embodiment.

FIG. 2 is a side view of the example heat exchanger embodiment.

FIG. 3 is a perspective view of a cast plate assembly embodiment.

FIG. 4 is an exploded view of example heat exchanger assembly embodiment.

FIG. 5 is a perspective view of another heat exchange assembly embodiment.

FIG. 6 is another cast plate heat assembly embodiment.

FIG. 7 is a perspective view of an example cast plate heat assembly embodiment.

FIG. 8 is a schematic view of a method of assembling a cast plate fin heat exchanger.

### DETAILED DESCRIPTION

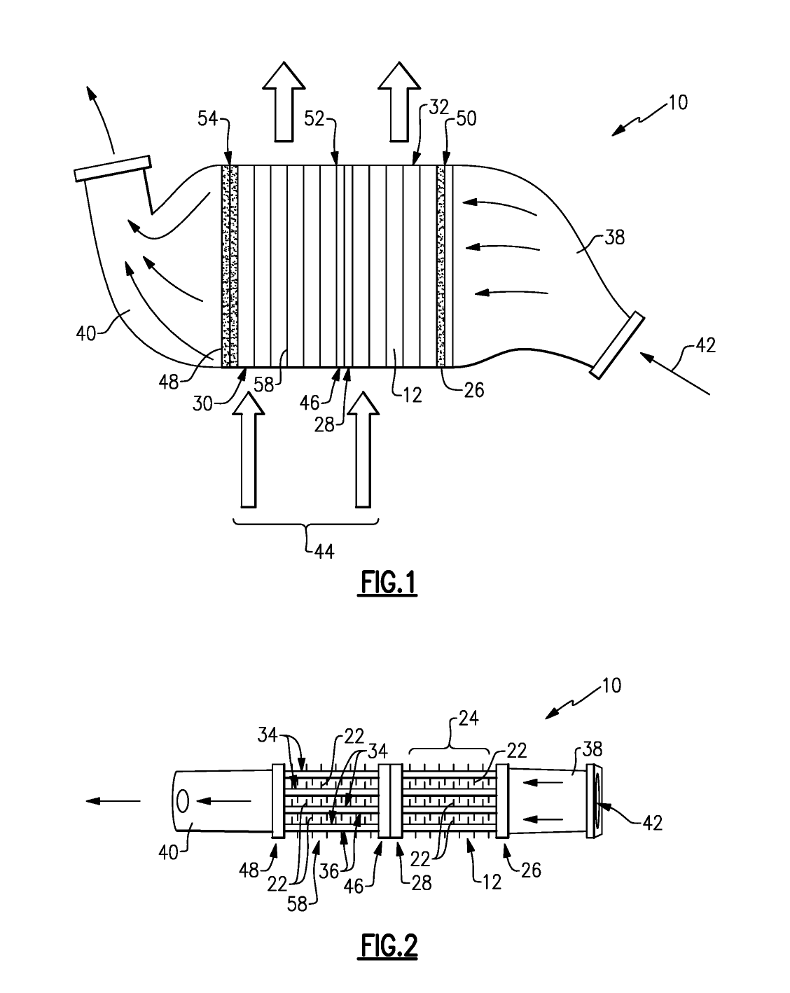

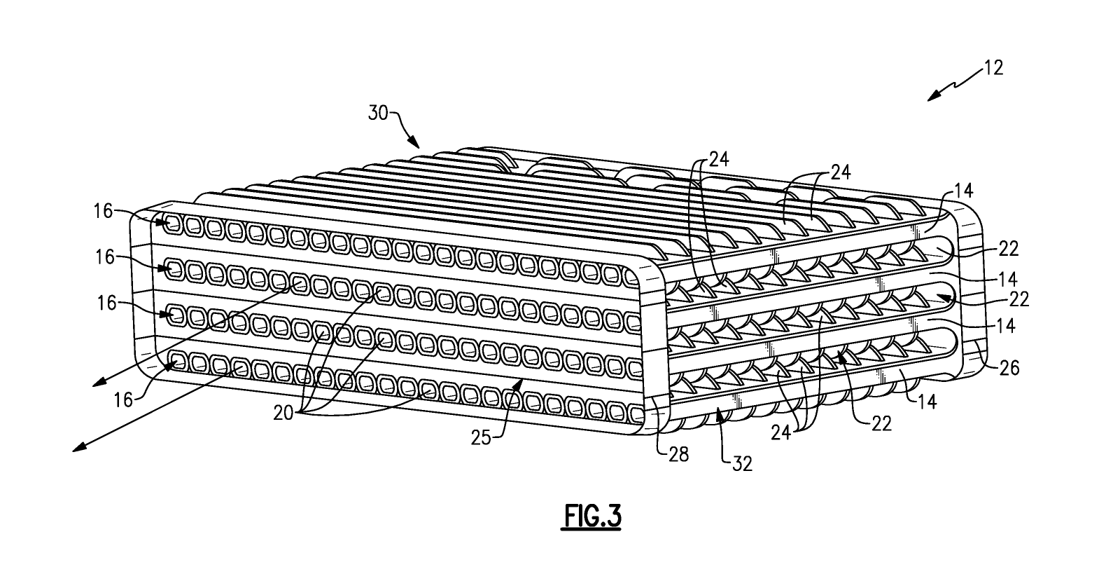

Referring to FIGS. 1 and 2, an example a heat exchanger 10 includes an inlet manifold 38 and an outlet manifold 40, a first cast plate 12, and second cast plate 58. The first cast plate 12 is attached to the intake manifold 38 at a first joint 50. The first cast plate 12 is attached to the second cast plate 58 at an intermediate joint 52. The second cast plate 58 is attached to the exhaust or outlet manifold 40 at an outlet joint 54. The example heat exchanger 10 utilizes one piece unitary cast plates 12, 58 to provide the cooling flow channels for cooling air flow 44 and the channels for a hot flow 42. Moreover, the example heat exchanger 10 utilizes the one-piece cast plates 12, 58 to simplify assembly and substantially reduce the number of brazed joints required in the example heat exchanger assembly 10.

Each of the cast plates 12, 58 includes a leading edge 30, a top surface 34, a bottom surface 36 and a trailing edge 32. Cooling airflow 44 enters cooling channels 22 disposed between plate portions 14 defined as part each of cast plates 12, 58. Fin portions 24 extend from top and bottom surfaces of each of the plate portions 14.

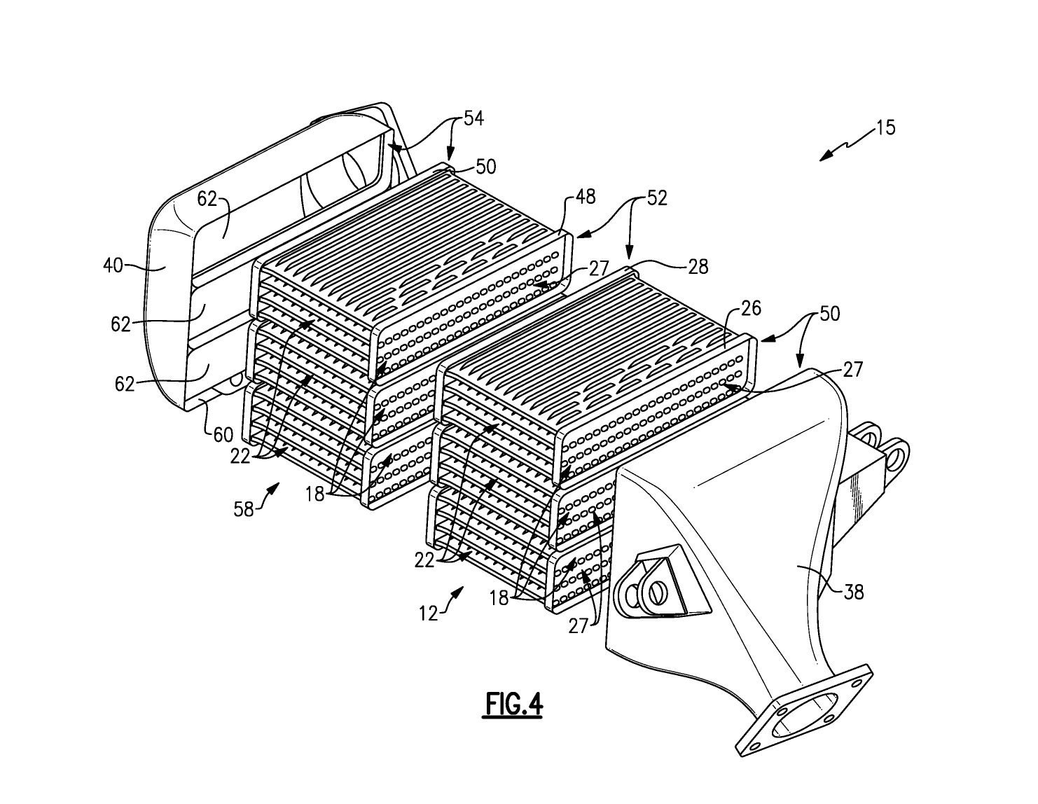

Referring to FIG. 3, with continued reference to FIGS. 1 and 2, the first cast plate assembly 12 is illustrated in a perspective view and includes a single unitary cast structure with plate portions 14 that extend between the leading edge 30 and the trailing edge 32. Each of the plate portions 14 define a plurality of internal passages 16 that extend between a corresponding plurality of inlets 18 (FIG. 4) and outlets 20. The outlets 20 from each of the plate portions 14 are shown in FIG. 3 and are disposed on a common outlet face 25. The common outlet face 25 is a surface that provides for each of the outlets 20 from the different plate portions 14 to open within a common plane. The inlets 18 are similarly disposed on a common inlet face 27 (FIG. 4) on the other side of the case plate 12 (Shown in FIG. 4).

The plurality of fins portions 24 extend from top and bottom surfaces 34, 36 of each of the plate portions 14. The cooling airflow through the cooling channels 22 flows between the plurality of fin portions 24 disposed on each of the plate portions 14.

The disclosed example cast plate 12 includes four plate portions 14 that define internal passages 16. Between the plate portions 14 are the cooling channels 22 for the cooling air flow 44. In this example there are three cooling channels 22 disposed between the four plate portions 14. Cooling air flow 44 will also flow over the top and bottom of the cast plate 12.

The plurality of inlets 18 and the plurality of outlets 20 are surrounded by a corresponding inlet perimeter and outlet perimeter 26, 28. The inlet perimeter 26 surrounds and defines an outer border around the inlets 18 on the common inlet face 27. The outlet perimeter 28 surrounds and defines an outer border around the outlets 20 on the common outlet face 25. The outlet perimeter 28 includes a smooth machined or ground surface that mates with an inner surface of the exhaust manifold 40.

Referring to FIG. 4 with continued reference to FIG. 3 another example heater exchanger assembly 15 is shown and includes the inlet manifold 38, the exhaust manifold 40 and a plurality cast plates 12. In this example there are three identical first cast plates 12 attached to three second cast plates 58. The first cast plates 12 are attached to the second cast plates 58 at an intermediate joint 52. The intermediate joint 52 is provided as a brazed joint between the first cast plates 12 and the second cast plates 58. An inlet joint 50 is provided between the inlet perimeter 26 of the first cast plates 12 and the inlet manifold 38. An outlet joint 54 is provided between the outlet perimeter 50 of the second cast plates 58 and the exhaust manifold 40. The exhaust manifold 40 includes an inner mating surface 60 that mates to the outlet perimeter at the outlet joint 54.

It should be appreciated that although identical plates are shown and disclosed by way of example that different cast plates 12 can be used to address application specific requirements.

In this example each of the intake manifold 38 and the exhaust manifold 40 includes separate sections illustrated at 62. Although not shown, the intake manifold 38 includes separate sections similar to those shown in the exhaust manifold 40. Each of the separate sections 62 correspond to one of the separate cast plates 12, 58 mated to the either the inlet manifold 38 or the outlet manifold 40. Although the example inlet manifold 38 and exhaust manifold 40 are shown and disclosed by way of example as including separate sections 62, a single open area to each of the inlet manifold 38 and exhaust manifold could also be utilized and is within the contemplation of this disclosure. Moreover, any combination of separate sections would also work with the cast plates 12, 58 disclosed by way of example.

The example heat exchanger 15 includes three first cast plates 12 stacked one on top of the other that are joined to the inlet manifold 38 at one of the separate portions 62. Each of the inlet manifold 38 and the exhaust manifold 40 includes the interior mating surface 60 that receives a corresponding one of the cast plates 12, 58.

As appreciated the example heat exchanger illustrated in FIG. 4 utilizes six cast plates 12, 58 of a common configuration and enable scaling the capacity of the heat exchanger 15 to meet application specific requirements and needs. The number of cast plates 12, 58 can be varied along with the orientation relative to each other to provide a heat exchanger of a desired capacity. More cast plates 12, 58 could be stacked upon one another to expand the heat exchanger vertically. Moreover, additional cast plates 12, 58 could be attached to each other to expand the heat exchanger lengthwise.

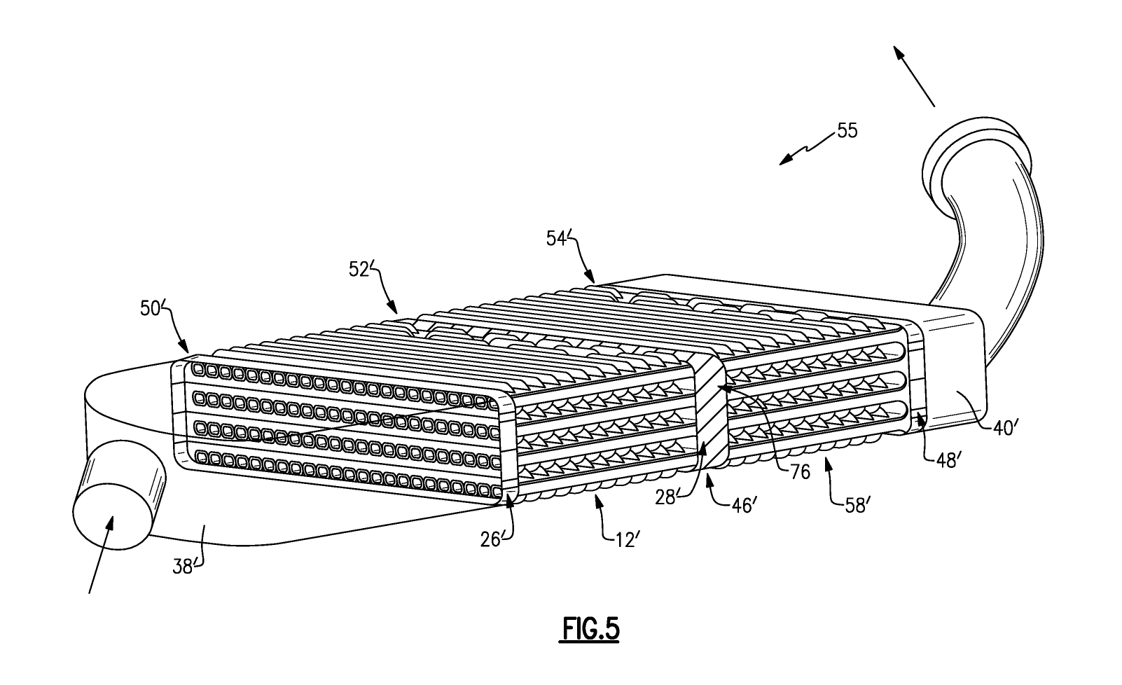

Referring to FIG. 5, another heat exchanger assembly 55 is shown and include a first cast plate 12′ attached to a second cast plate 58′. Only one row of two cast plates 12′, 58′ are provided to provide the desired heat exchanging capacity. The first cast plate 12′ is attached to the second cast plate 58 at an intermediate joint 52′. The first cast plate 12′ is attached to the inlet manifold 38 at an inlet joint 50′ and the second cast plate 58′ is attached to the outlet manifold 40 at an outlet joint 54′. The first cast plate 12′ includes an inlet perimeter 26′ that provides the interface with the inlet manifold 38 at the inlet joint 50′. The second cast plate 58′ includes an outlet perimeter 48′ that provides the interface with the outlet manifold 40′. The intermediate joint 52′ is defined between an outlet perimeter 28′ if the first cast plate 12′ and an inlet perimeter 46′ of the second cast plate 58′. The outlet perimeter 28′ may be attached directly to the inlet perimeter 46′. Alternatively, a band 76 could be wrapped around the two perimeters 28′, 46′ to aid in forming the intermediate joint 52′.

The joints 50, 52, 54, 50′, 52′ and 54′ are disclosed by way of example as brazed joints. However, other joining and welding processes and method as are known could be utilized and are within the contemplation of this disclosure. For example, friction welding, laser welding and plasma welding may be utilized for form one or all of the disclosed joints. Additionally, the number of joints required to form the disclosed example heat exchangers are significantly reduced as compared to traditional heat exchanger construction and therefore enables the use of welding, brazing techniques not previously practical.

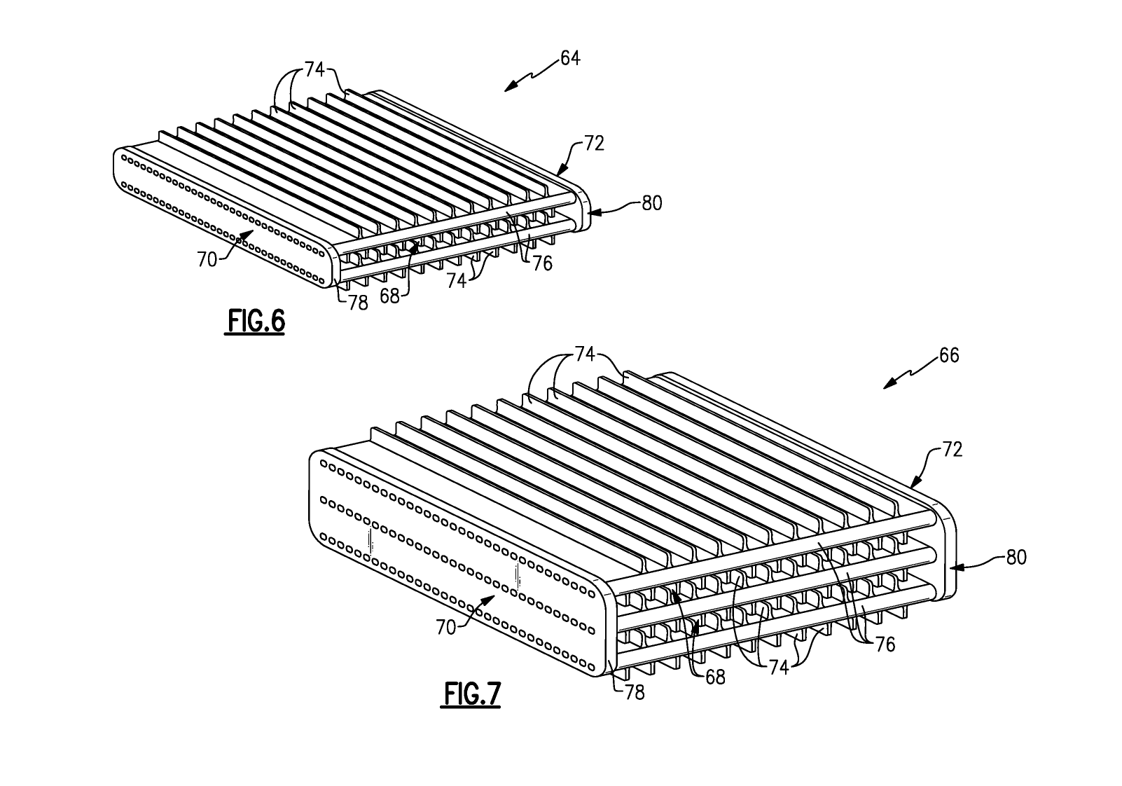

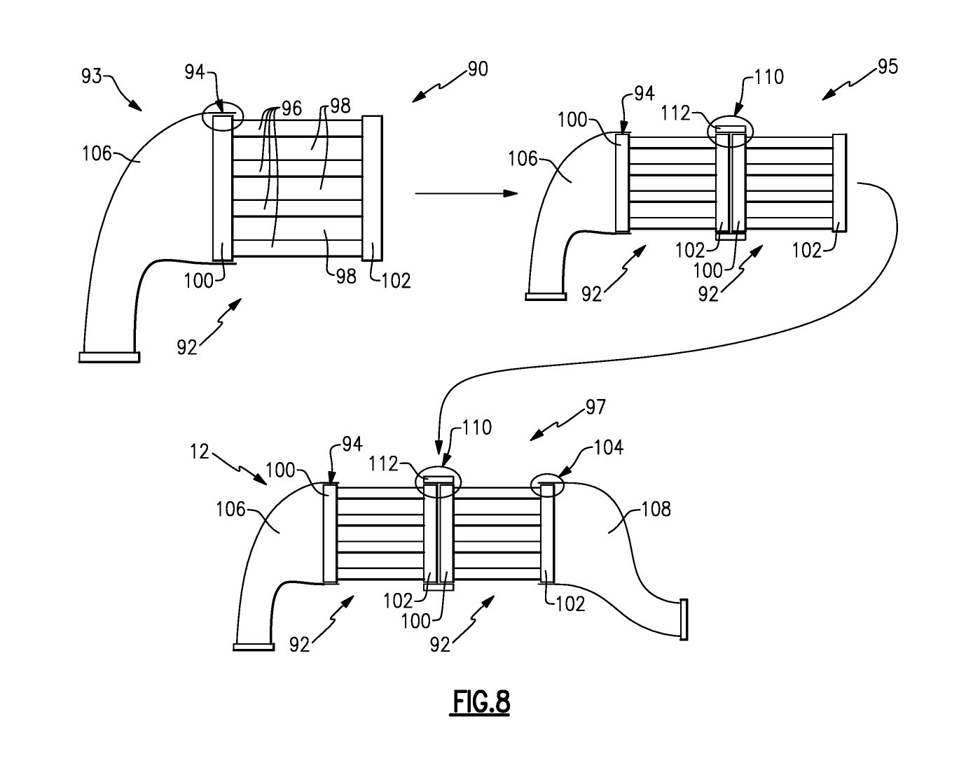

Referring to FIGS. 6 and 7, although the previous example embodiments have included plate assemblies 12′ and 58′ that include four plate portions 14 and three cooling flow channels other cast plate configuration could be utilized and are within the contemplation of this disclosure.

FIG. 6 illustrates an example cast plate 64 with two plate portions 76 disposed between an inlet face 70 and outlet face 72. Each of the plate portions 76 include a plurality of fins 74 and form the cooling flow channel 68 there between.

Referring to FIG. 7, another cast plate 66 is illustrated and includes three plate portions 76 forming two cooling channels 68 there between. Each of the plate portions 76 includes internal passages that extend between a corresponding plurality of inlets and outlets similar to the previous disclosed cast plate 12 shown in FIG. 4.

Both cast plates 64 and 66 include inlet perimeters 78 and outlet perimeters 80 that surround the corresponding inlet face 70 and outlet face 72. The perimeters 78, 80 provide a surface for forming a desired joint with another cast plate or a manifold.

Each of disclosed cast plates 12, 58, 12′, 58′, 64 and 66 are single one piece unitary cast structures that are formed complete with internal passages, fin portions and perimeters. Secondary machining to refine the joint surfaces defined at the perimeters is all that may be desired. The inclusion of the fin portion with the plate portions as a casting eliminates many joints that can complicate assembly and limit operational capabilities.

Referring to FIG. 8 with continued reference to FIGS. 3 and 4, an example method of assembling a heat exchanger 10 is schematically shown and generally indicated at 90 and includes an initial of step shown at 93 of mating a first cast plate 92 to an inlet manifold 106 at an inlet joint 94. The inlet joint 94 is provided as a brazed or welded joint between an inlet perimeters 100 an interior surface of the inlet manifold 106. The cast plate 92 includes plate portions 96 and cooling channels 98 between the plate portions 96. Once the inlet manifold 106 is joined to the cast plate 92, a second cast plate 92 is attached to the first cast plate as is indicated at 95. An intermediate joint 110 is formed using a band 112 that surrounds both the outlet perimeter 102 of the first cast plate 92 and an inlet perimeter 100 of the second cast plate 92.

In this disclosed example, the first cast plate 92 and the second cast plate are identically shaped and configured cast structures. Once the intermediate joint 110 is complete, the exhaust manifold 108 is joined at an outlet joint 104 as indicated at 97. The outlet joint 104 is also a brazed or welded joint between the outlet perimeter 102 and an inner surface of the exhaust manifold 108. Accordingly, the disclosed heat exchangers can be constructed with a minimal number of joints.

Moreover, the disclosed example heat exchangers maybe scaled up or down depending on application specific requirements by adding additional cast plates that are joined to corresponding manifolds in a serial or parallel manner.

Although an example embodiment has been disclosed, a worker of ordinary skill in this art would recognize that certain modifications would come within the scope of this disclosure. For that reason, the following claims should be studied to determine the scope and content of this disclosure.

1. A plate fin heat exchanger comprising:
a first cast plate assembly including at least two plate portions separated by at least one cooling channel, each of the two plate portions including a plurality of internal passages extending between a corresponding plurality of inlets and outlets, wherein a common inlet perimeter surrounds the plurality of inlets from each of the two plate portions and a common outlet perimeter surrounds the plurality of outlets from each of the two plate portions;
an inlet manifold attached at an inlet joint to the common inlet perimeter; and
an outlet manifold attached at an outlet joint to the common outlet perimeter.

2. The plate fin heat exchanger as recited in claim 1, including a second cast plate assembly including a second inlet perimeter attached to the outlet perimeter of the first cast plate assembly at an intermediate joint and the outlet manifold is attached to the outlet perimeter of the second cast plate assembly.

3. The plate fin heat exchanger as recited in claim 1, wherein the first cast plate assembly includes a plurality of fin portions that extend from top and bottom surface of the plate portions.

4. The plate fin heat exchanger as recited in claim 1, including at least one additional cast plate assembly with an inlet perimeter attached at an additional inlet joint to the inlet manifold and an outlet perimeter attached at an additional inlet joint to the outlet manifold.

5. The plate fin heat exchanger as recited in claim 2, wherein the inlet manifold and the outlet manifold include a first passage in communication with the first cast plate assembly and a second passage in communication with the second cast plate assembly.

6. The plate fin heat exchanger as recited in claim 1, wherein the at least two plate portions comprises three plate portions including a top plate portion, an intermediate plate portion and bottom plate portion with a cooling channel defined on either side of the intermediate plate portion.

7. The plate fin heat exchanger as recited in claim 1, wherein the at least two plate portions comprises four plate portions including at top plate portion, a first intermediate plate portion, a second intermediate plate portion and a bottom plate portion with the cooling channel defined between the plate portions.

8. The plate fin heat exchanger as recited in claim 1, wherein the inlet joint comprises a brazed joint between the inlet perimeter and an internal surface of the inlet manifold and the outlet joint comprises a brazed joint between the outlet perimeter and an internal surface of the outlet manifold.

9. The plate fin heat exchanger as recited in claim 1, wherein the common inlet perimeter and the common outlet perimeter comprise smooth surfaces on outer surfaces of opposing distal ends.

10. The plate fin heat exchanger as recited in claim 1, wherein the common inlet perimeter and the common outlet perimeter are parts separate from the first cast plate assembly.

11. The plate fin heat exchanger as recited in claim 1, wherein the common inlet perimeter and the common outlet perimeter are integral parts of the first cast plate assembly.

12. The plate fin heat exchanger as recited in claim 1, wherein the cast plate assembly comprises a single unitary cast item.

13. A plate fin heat exchanger comprising:
a first cast plate assembly including at least two plate portions separated by at least one cooling channel, each of the two plate portions including a plurality of internal passages extending between a corresponding plurality of inlets and outlets, wherein an inlet perimeter surrounds the plurality of inlets from each of the two plate portions and an outlet perimeter surrounds the plurality of outlets from each of the two plate portions;
a second cast plate assembly including at least two second plate portions separated by at least one second cooling channel, each of the two second plate portions including a second plurality of internal passages extending between a second corresponding plurality of inlets and outlets, wherein the second cast plate assembly includes a second inlet perimeter surrounding the second plurality of inlets of the second cast plate that is attached to the outlet perimeter of the first cast plate assembly;
an inlet manifold attached at an inlet joint to the first inlet perimeter of the first cast plate assembly; and
an outlet manifold is attached at an outlet joint to the outlet perimeter of the second cast plate assembly.

14. The plate fin heat exchanger as recited in claim 13, wherein the first cast plate assembly and the second cast plate assembly both include a plurality of fin portions that extend from top and bottom surfaces of the plate portions.

15. The plate fin heat exchanger as recited in claim 13, wherein the inlet perimeter and the outlet perimeter are parts separate from the first cast plate assembly and the second cast plate assembly.

16. The plate fin heat exchanger as recited in claim 13, wherein the inlet perimeter and the outlet perimeter are integral parts of the first cast plate assembly and the second cast plate assembly.

17. The plate fin heat exchanger as recited in claim 13, wherein first cast plate assembly and the second cast plate assembly each comprise separate unitary cast items.

18. A method of assembling a heat exchanger comprising:
joining a first cast plate assembly to an inlet manifold at an inlet joint, wherein the first cast plate assembly includes at least two plate portions separated by at least one cooling channel to an inlet manifold, wherein each of the at least two plate portions include a plurality of internal passages extending between a corresponding plurality of inlets and outlets and an inlet perimeter surrounds the plurality of inlets from each of the two plate portions and an outlet perimeter surrounds outlets from each of the two plate portions;
joining an outlet manifold at an outlet joint to the outlet perimeter of the first cast plate assembly.

19. The method as recited in claim 18, further comprising joining a second cast plate assembly between the first cast plate assembly and the outlet manifold, wherein the second cast plate assembly is identical to the first cast plate assembly and a second inlet perimeter of the second cast plate is joined to the first outlet perimeter of the first cast plate assembly at an intermediate joint and a second outlet perimeter of the second cast plate assembly is jointed at the outlet joint to the outlet manifold.

20. The method as recited in claim 19, wherein the first cast plate assembly and the second cast plate assembly both include a plurality of fin portions extending from top and bottom surfaces of the at least two plate portions.

21. The method as recited in claim 19, wherein first cast plate assembly and the second cast plate assembly each comprise separate unitary cast items.
